(19) United States
(12) Patent Application Publication
(10) Pub. No.: US 2016/0129307 A1
(43) Pub. Date: May 12, 2016

(54) MOTION DETECTION DEVICE, HOLDER, AND MOTION BODY WITH SENSOR

(71) Applicant: SEIKO EPSON CORPORATION, Tokyo (JP)

(72) Inventor: Yuya ISHIKAWA, Chino-shi (JP)

(21) Appl. No.: 14/933,448

(22) Filed: Nov. 5, 2015

(30) Foreign Application Priority Data
Nov. 12, 2014 (JP) 2014-229800

(51) Int. Cl. A63B 24/00; G01P 15/18

(52) U.S. Cl. CPC A63B 24/0003; G01P 15/18

(57) ABSTRACT

A motion detection device which is attached to a motion body and detects a motion thereof, includes a sensor that detects the motion, and a holder that includes a fixation unit which is attached to the motion body so as to fix the sensor to the motion body, in which the holder further includes a first terminal that is provided at the fixation unit, and an antenna that is connected to the first terminal, and in which the sensor includes a second terminal that is electrically connected to the first terminal when attached to the holder.

### BACKGROUND

1. Technical Field

The present invention relates to a motion detection device, a holder, and a motion body with sensor.

2. Related Art

As a method of analyzing and evaluating swing motions of a golf club, a baseball bat, or rackets of tennis and the like, and a human body which handles such a motion body, a method of performing analysis on the basis of an image captured by a camera is known. There is an accuracy limit in the analysis using an image, and thus it is attempted to perform motion analysis with higher accuracy by using an acceleration sensor, a gyro sensor, or the like. For example, JP-A-11-169499 discloses a swing analysis device in which a sensor which can measure acceleration in three axes is attached to a grip of a golf club, and a swing is analyzed.

Information such as acceleration measured by a sensor which is attached to a target object (for example, a motion body) is desired to be collected in the way of not being a hindrance to a motion of the target object as much as possible. For this reason, it is preferable to transmit data measured by the sensor in a wireless manner instead of using a signal line such as a cord. If the data measured by the sensor is transmitted in a wireless manner, and is received and analyzed by, for example, a PC terminal, it is possible to minimize a hindrance to a motion of the target object and thus to perform more accurate analysis. Also in a case where control information is sent to the sensor, transmission and reception thereof is preferably performed via wireless communication.

On the other hand, in a case where a sensor is attached to a motion body such as a golf club or a baseball bat, and motion analysis is performed, there are demands for reduction in weight of the sensor in order for a user not to have a massive feeling and for miniaturization in order for the user not to have a sense of visual discomfort. Under these demands, there is an attempt to attach the sensor to the motion body by using an attachment tool (attachment member).

However, if an antenna is provided to be stored in the sensor in order to transmit a measurement result in the sensor in a wireless manner, there is a case where a radio wave is shield by a member or a constituent element around the sensor unit, or a measurement target object (a motion body or the like), and thus signal intensity is reduced. For this reason, when the antenna is provided in the sensor, there are various limitations such as an arrangement of a member or a constituent element around the antenna or provision of a space around the antenna, and thus this is a hindrance to miniaturization of, especially, the sensor.

### SUMMARY

An advantage of some aspects of the invention is to provide a motion detection device which has a small size and can obtain motion information of a motion body with high sensitivity through wireless communication.

The invention can be implemented as the following forms or application examples.

### APPLICATION EXAMPLE 1

This application example is directed to a motion detection device which is attached to a motion body and detects a motion thereof, including a sensor that detects the motion; and a holder that includes a fixation unit which is attached to the motion body so as to fix the sensor to the motion body, in which the holder further includes a first terminal that is provided at the fixation unit, and an antenna that is connected to the first terminal, and in which the sensor includes a second terminal that is electrically connected to the first terminal when attached to the holder.

The motion detection device has a small size, and can efficiently perform wireless communication with an external device when attached to a motion body which is moved. Consequently, it is possible to obtain motion information of the motion body with high sensitivity by using the wireless communication.

### APPLICATION EXAMPLE 2

In the motion detection device according to Application Example 1, the fixation unit of the holder and the sensor may be respectively provided with fitting portions, and the fitting portions may be fitted to each other, and thus the sensor and the holder may be fixed to each other.

The motion detection device according to this application example can be easily attached to the motion body.

### APPLICATION EXAMPLE 3

In the motion detection device according to Application Example 2, the first terminal and the second terminal may be respectively provided at the fitting portions of the fixation unit of the holder and the sensor.

In the motion detection device according to this application example, the first terminal and the second terminal can be brought into contact with each other when the motion detection device is attached to the motion body.

### APPLICATION EXAMPLE 4

In the motion detection device according to any one of Application Examples 1 to 3, the holder may be formed of a curved plate, and the antenna may be provided inside the curved plate of the holder.

In the motion detection device according to this application example, the antenna is prevented from being rusty or deformed.

### APPLICATION EXAMPLE 5

In the motion detection device according to any one of Application Examples 1 to 4, the antenna may be provided in the holder in a folded shape.

The motion detection device according to this application example can perform wireless communication with higher sensitivity by taking a sufficient length of the antenna.

### APPLICATION EXAMPLE 6

In the motion detection device according to any one of Application Examples 1 to 5, information maybe transmitted and received by using the antenna, and the transmitted and received information may be transmitted to the sensor.

The motion detection device according to this application example can perform information communication with an external communication apparatus, for example, a portable information terminal such as a smart phone, or a personal computer, and can thus perform motion analysis with high accuracy.

### BRIEF DESCRIPTION OF THE DRAWINGS

The invention will be described with reference to the accompanying drawings, wherein like numbers reference like elements.

FIG. 1 is an exterior perspective view illustrating a state in which a holder according to an embodiment is attached to a motion body (golf club).

FIG. 2 is an enlarged view of a region indicated by A in FIG. 1, and is a schematic diagram illustrating a state in which a sensor is being fitted to the holder according to the embodiment.

FIG. 3 is an enlarged view of the region indicated by A in FIG. 1, and is a schematic diagram illustrating the motion body with sensor in a state in which the holder according to the embodiment is attached to the motion body, and the sensor is fitted to the holder.

FIG. 4 is a perspective view illustrating the holder according to the embodiment, and is a perspective view which is viewed from an arrow direction indicated by J in FIG. 12.

FIGS. 5A to 5C are schematic diagrams illustrating some examples of an antenna provided in the holder according to the embodiment, in which FIG. 5C corresponds to a state in which the holder is virtually developed in a plane.

FIG. 6 is a schematic diagram in which the sensor according to the embodiment is viewed from the top in a planar manner.

FIG. 7 is a schematic diagram in which the sensor according to the embodiment is viewed from the bottom in a planar manner.

FIG. 8 is a schematic diagram in which the sensor according to the embodiment is viewed from an arrow direction indicated by F in FIG. 6.

FIG. 9 is a schematic sectional view in which the sensor according to the embodiment is cut along the line B-B′ in FIGS. 6 and 7.

FIG. 10 is a schematic sectional view in which the sensor according to the embodiment is cut along the lines C-C′ and E-E′ in FIGS. 7 and 8.

FIG. 11 is a schematic diagram in which the holder according to the embodiment is viewed from an attachment surface side in a planar manner.

FIG. 12 is a schematic diagram in which the holder according to the embodiment is viewed from an arrow direction indicated by G in FIG. 11.

FIG. 13 is a schematic diagram in which the holder according to the embodiment is viewed from an arrow direction indicated by H in FIG. 11.

FIG. 14 is a schematic sectional view illustrating a state in which the holder according to the embodiment is attached to the motion body (golf club).

FIG. 15 is a schematic sectional view illustrating a state in which the sensor is fitted to the holder according to the embodiment.

FIG. 16 is an enlarged view of a region indicated by J in FIG. 15.

FIG. 17 is a schematic sectional view taken along the line L-L′ in FIG. 16.

FIG. 18 is a schematic sectional view taken along the line M-M′ in FIG. 17.

FIG. 19 is a schematic enlarged view illustrating an operation state of a pressing protrusion.

FIGS. 20A to 20D are schematic diagrams illustrating some examples of exteriors of a direction indicator in the sensor.

FIG. 21 is an exterior view illustrating a motion body with sensor and a motion analysis apparatus according to the embodiment.

FIG. 22 is a block diagram illustrating the motion analysis apparatus according to the embodiment.

### DESCRIPTION OF EXEMPLARY EMBODIMENTS

Hereinafter, some embodiments of the invention will be described. The embodiments described below are to describe an example of the invention. The invention is not limited to the following embodiments, and includes various modification examples which occur within the scope without departing from the spirit of the invention. All constituent elements described below are not essential constituent elements of the invention.

### 1. Holder

A holder of the present embodiment includes a first terminal, has a curved plate shape, and is attached to a motion body so as to hold the motion body. The holder is a tool or an attachment for attaching an electronic component such as a sensor to be described later to the motion body.

### 1.1 Motion Body

A description will be made of the motion body to which the holder and the sensor are attached. The motion body to which the holder of the present embodiment is attached has a shape which can be held, such as a bar shape, a columnar shape, a tubular shape, and is not limited as long as the motion body performs motions (a spatially positional movement, a change in a shape or an attitude, rotation, vibration, and the like). Such a motion body may include appliances or tools used in various sports, for example, a golf club, a baseball bat, rackets of tennis and the like, and a bamboo sword, and objects other than the appliances or tools, for example, parts of the human body such as arms or legs, or a movable portion such as an arm of a robot apparatus.

Hereinafter, a description will be made of a case where the motion body is a golf club. Regarding the golf club, although not particularly limited, a golf club in which a rubber grip is attached to a shaft thereof will be described. In the description thereof, an aspect in which the holder of the present embodiment holds the rubber grip portion will be described, but the holder may hold the shaft or may hold a boundary therebetween.

### 1.2 Shape of Holder

The holder has a curved plate shape. The holder has a shape which holds a bar-shaped motion body. The holder is attached to the motion body by holding the motion body. A holder 20 of the present embodiment holds a golf club 200 (motion body). The holder 20 may include other members (for example, a mechanism fixing a sensor 10).

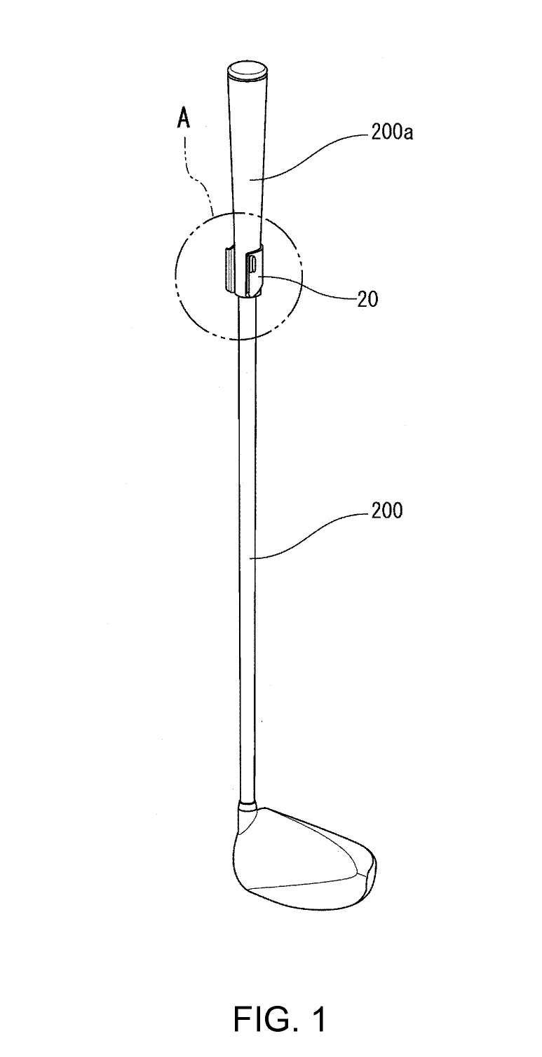

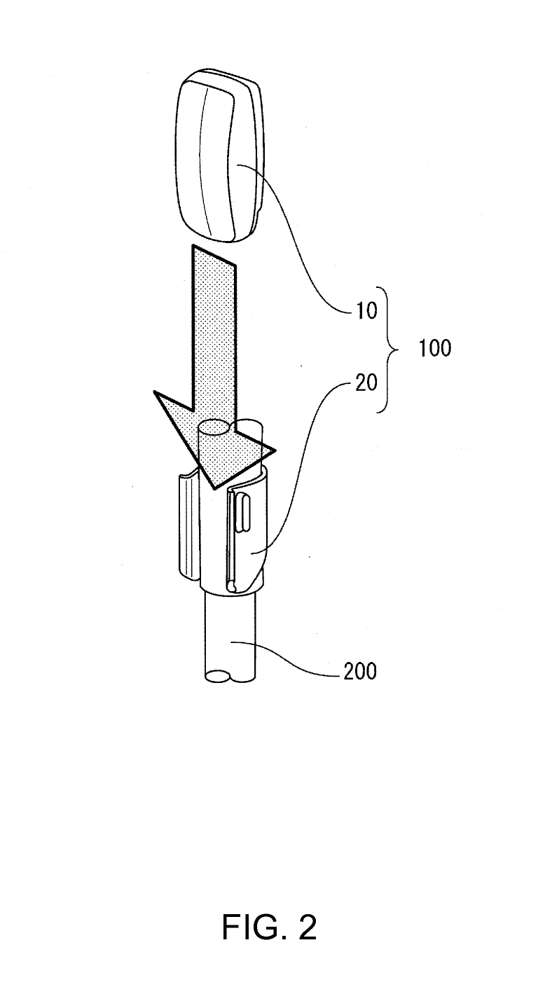

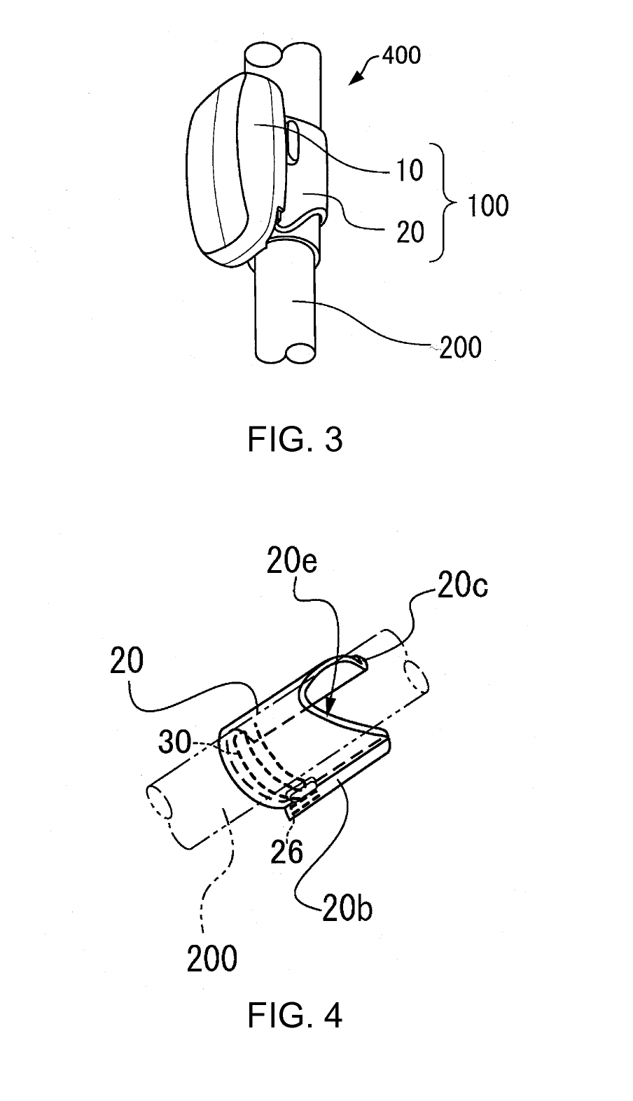

FIG. 1 is an exterior perspective view illustrating a state in which the holder 20 according to the present embodiment is attached to the golf club 200 (motion body). FIG. 2 is an enlarged view of a region indicated by A in FIG. 1, and is a schematic diagram illustrating a state in which the sensor 10 is being fitted to the holder 20 according to the present embodiment. FIG. 3 is an enlarged view of the region indicated by A in FIG. 1, and is a schematic diagram illustrating a state in which the sensor 10 is fitted to the holder 20 according to the present embodiment.

As illustrated in FIG. 1, the sensor 10 including a sensor unit 13 (not illustrated) such as an inertial sensor is attached to the holder 20 which can be attached to a grip portion 200a of the golf club 200, via fitting portions 20b and 20c illustrated in FIG. 4 in an arrow direction illustrated in FIG. 2. Thus, the sensor 10 is attached to the golf club 200 as illustrated in FIG. 3.

As illustrated in FIG. 3, a motion detection device 100 (including the holder 20 and the sensor 10 fitted to the holder 20) according to the present embodiment is attached to the golf club 200 as a motion body which is moved. In other words, in a case where the holder 20 is attached to the golf club 200 and thus the fitting portions 20b and 20c are fitted to the sensor 10, the sensor 10 is attached to the golf club 200 so as to surround the golf club 200.

Here, in the present specification, the phrase, “the holder holds an motion body”, indicates that the holder is attached and fixed to (holds) the motion body so as to grasp (clutch or grip) the motion body having a bar shape, a columnar shape, or a tubular shape, and indicates a state in which the holder is fixed (supported) thereto so as not to cover the entire circumference of the motion body but to cover at least a half circumference of the motion body. Such an aspect may be replaced with a phrase, “the holder grips the motion body” or “the holder is attached to the motion body so as to grip the motion body”.

A material of the holder 20 is not limited as long as a grasping force (pressing force) for holding the golf club 200 is obtained, but, for example, synthetic resin such as polyethylene, polypropylene, polystyrene, polyvinyl chloride, polycarbonate, ABS resin, fluorine resin, acrylic resin, or copolymers thereof may be used and the material can contribute to reduction in weight of the holder 20.

### 1.3 Fitting Portion

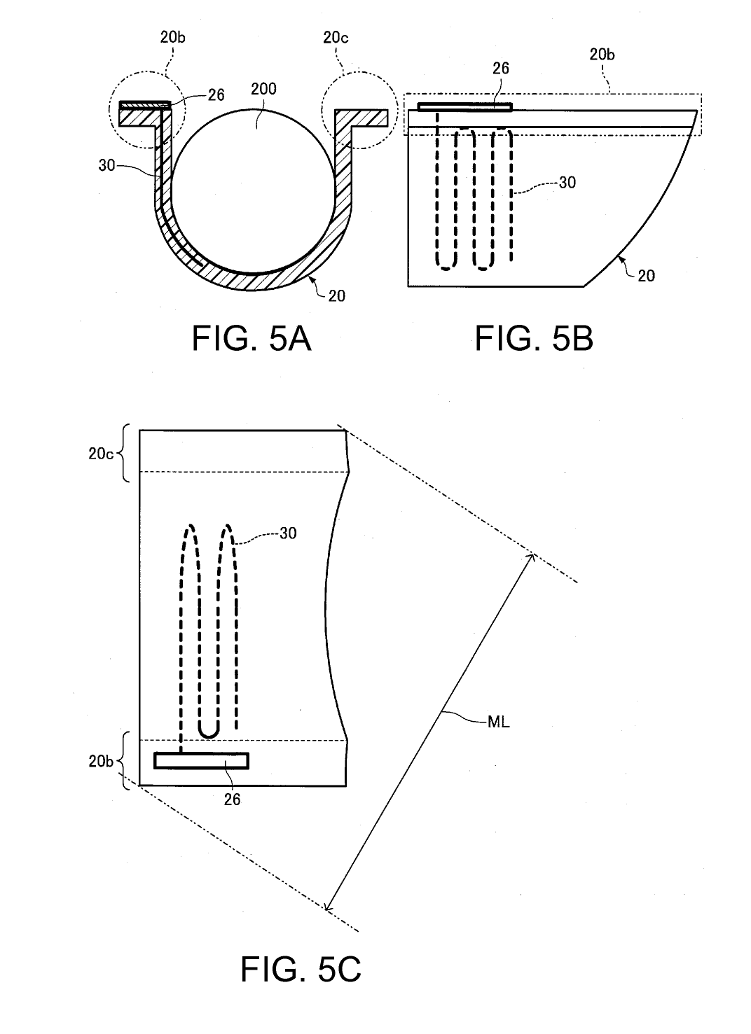

The holder 20 may be provided with the fitting portions 20b and 20c on tip end sides holding the motion body, as the fixation unit. The holding tip end sides are portions which initially grasp the motion body when the holder 20 holds the motion body, and can be said to be tip end sides which are separated from an axis extending in a length direction of the motion body when the holder 20 is virtually developed as illustrated in FIG. 5C.

The fitting portions 20b and 20c function as a configuration for fitting to the sensor 10 to be described later, for example. The fitting portions 20b and 20c can stably attach the sensor 10 to the golf club 200 so that the sensor 10 is unlikely to be dropped out, positionally deviated, or rotated.

A first terminal 26 which will be described later is provided in the fitting portion 20b and/or the fitting portion 20c. A shape of the first terminal 26 provided in the fitting portions 20b and 20c is not particularly limited, but each of the terminals has a shape which enables electrical connection with a second terminal 16 of the sensor 10 illustrated in FIG. 7 when the fitting portions 20b and 20c are appropriately fitted to the sensor 10. In the illustrated example, the first terminal 26 is provided in the fitting portion 20b. As details of the fitting portions 20b and 20c will be described later, in a case where the holder 20 is attached to the golf club 200, and the fitting portions 20b and 20c are fitted to the sensor 10, the sensor 10 and the holder 20 (motion detection device 100) are attached to the golf club 200 so as to surround the golf club 200. In a case where the fitting portions 20b and 20c are fitted to the sensor 10, the extent of fastening toward the golf club 200 may be made to be increased. In the above-described way, the sensor 10 can be stably attached to the golf club 200 so as to be unlikely to be dropped out, positionally deviated, or rotated.

In the present embodiment, there is an aspect in which the fitting portions 20b and 20c have a rail shape and are slid and fitted to the sensor 10 through insertion into grooves (refer to grooves 11d and 11e in FIG. 7) of the sensor 10, but the present embodiment is not particularly limited as long as the sensor 10 can be fixed to the golf club 200.

### 1.4 Sensor

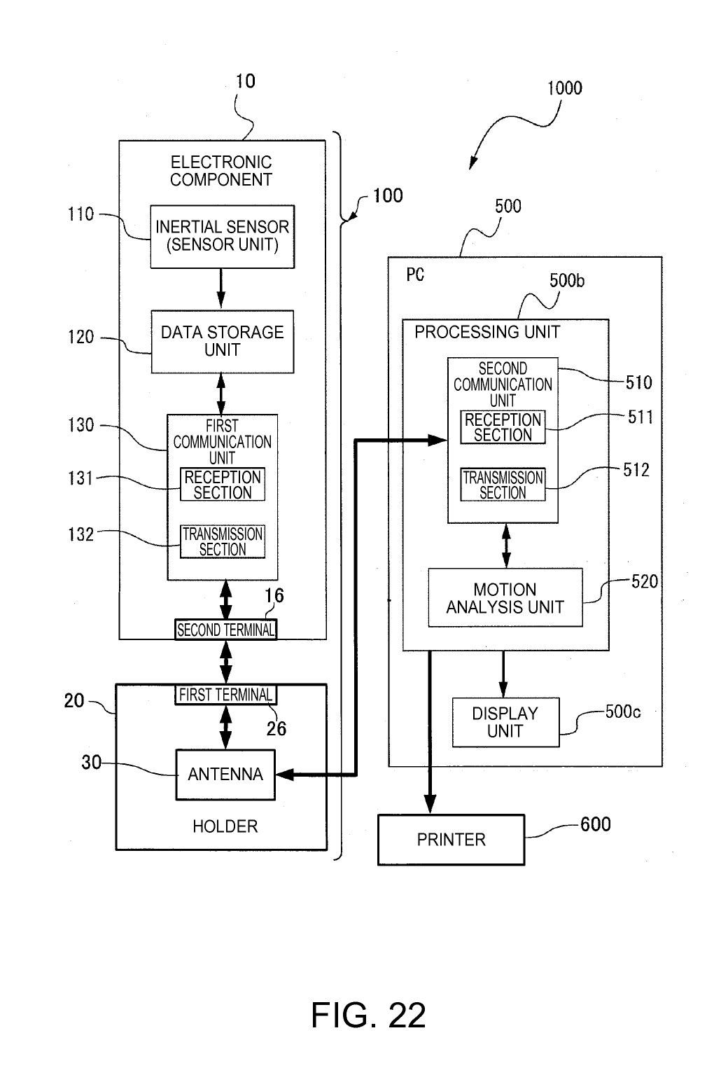

The sensor 10 includes the second terminal 16 which comes into contact with the first terminal 26 of the holder 20. The second terminal 16 is connected to a first communication unit 130 (refer to FIG. 22) provided in the sensor 10. Power is supplied to an antenna 30 connected to the first terminal 26 of the holder 20, via the second terminal 16.

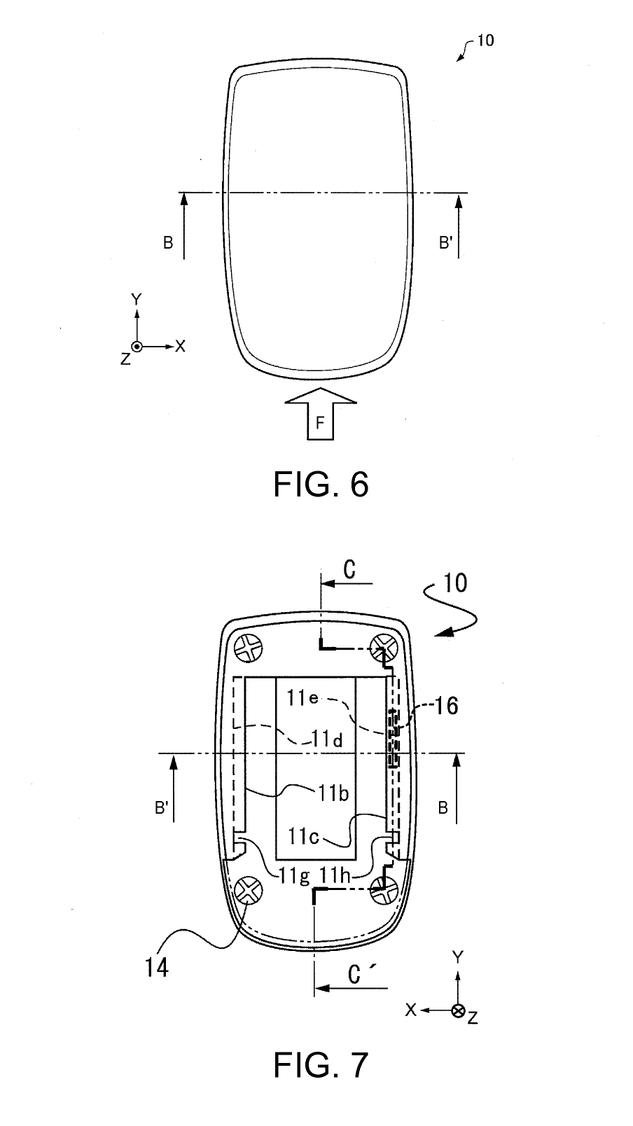

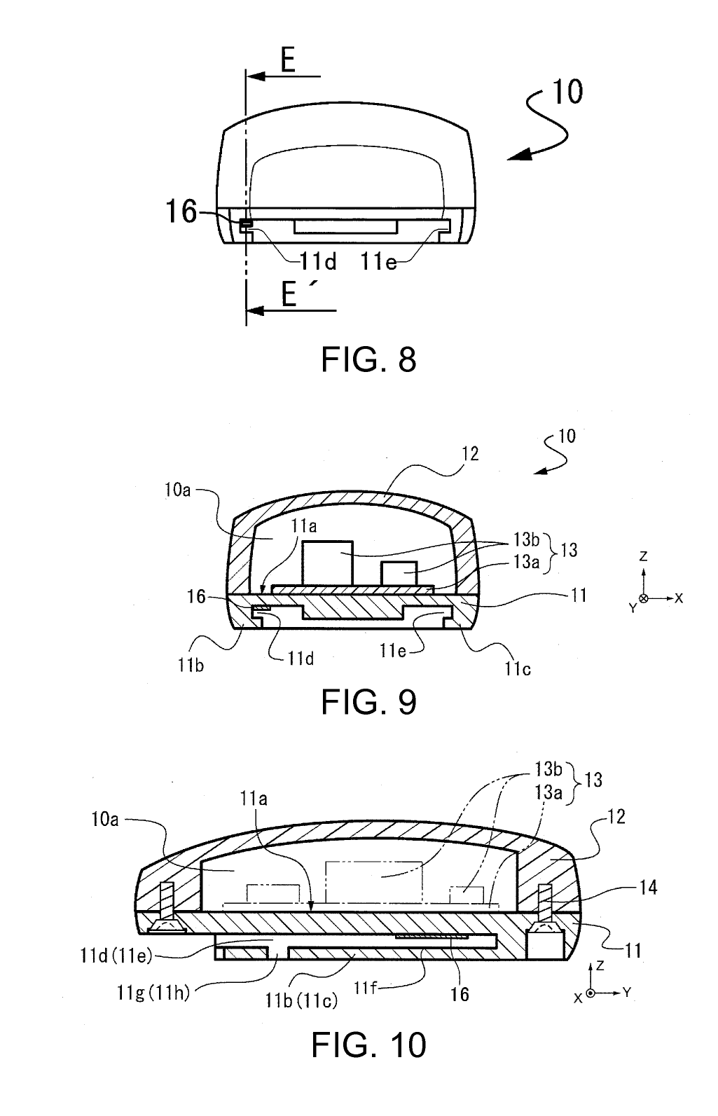

The sensor 10 will be described with reference to FIGS. 6 to 10. In FIGS. 6 to 10, the wiring or the like extending from the second terminal 16 is not illustrated. As illustrated in FIGS. 9 and 10, the sensor 10 includes a casing in which an internal space 10a is formed by a cover 12 which is fixed to a base 11 via screws 14. The sensor unit 13 as a detection unit of the sensor 10 is fixed to a surface 11a of the base 11 on the internal space 10a side in a method such as adhesion, and the sensor unit 13 is constituted of electronic devices 13b and a circuit board 13a on which the electronic devices 13b are mounted. At least one of the electronic devices 13b is an inertial sensor. The sensor unit 13 may include an acceleration sensor or an angular velocity sensor. The sensor unit 13 may be appropriately configured so as to analyze, for example, motions in three axes.

A method of fixing the cover 12 to the base 11 is not limited to the screws 14, and the cover 12 may be fixed to the base 11 through, for example, adhesion, and may be fixed to the base 11 through welding if the base 11 and the cover 12 are made of plastic.

The base 11 is provided with a protrusion 11b and a protrusion 11c which extend so as to be in parallel to each other in the illustrated Y direction as illustrated in FIGS. 7 to 10. A groove 11d as a depression is formed in the protrusion 11b in the Y direction, and a groove 11e as a depression is also formed in the protrusion 11c in the Y direction. Openings of the groove 11d and the groove 11e in the X direction are formed so as to face each other. Sides of the groove 11d and the groove 11e in the −Y direction, that is, the sides in the direction in which the sensor 10 is installed, illustrated in FIG. 2, are open, and sides in the opposite direction are formed as a groove wall 11f (refer to FIGS. 9 and 10 together). As engaging portions which are engaged with detachment prevention protrusions of the holder 20, a notch 11g is formed in the protrusion 11b, and a notch 11h is formed in the protrusion 11c.

The second terminal 16 which will be described later is provided at the groove 11d and/or the groove 11e. A shape of the second terminal 16 provided at the grooves 11d and/or 11e is not particularly limited, but the terminal has a shape which enables electrical connection with the first terminal 26 of the holder 20 when the fitting portions 20b and 20c are respectively fitted to the grooves 11d and 11e. In the illustrated example, the second terminal 16 is provided at the groove 11e.

### 1.5 Fitting and Assembling

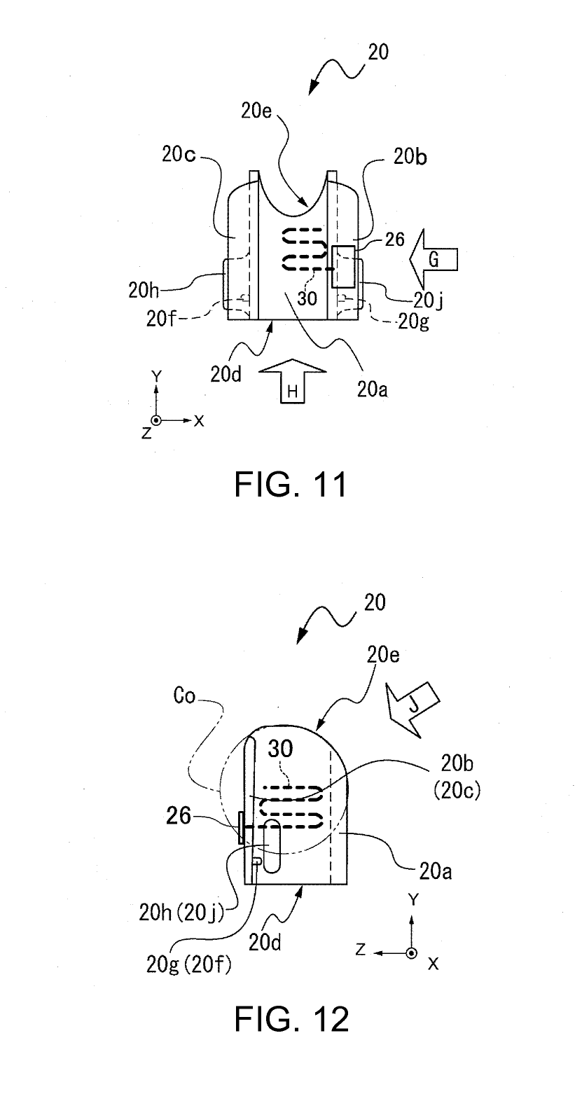

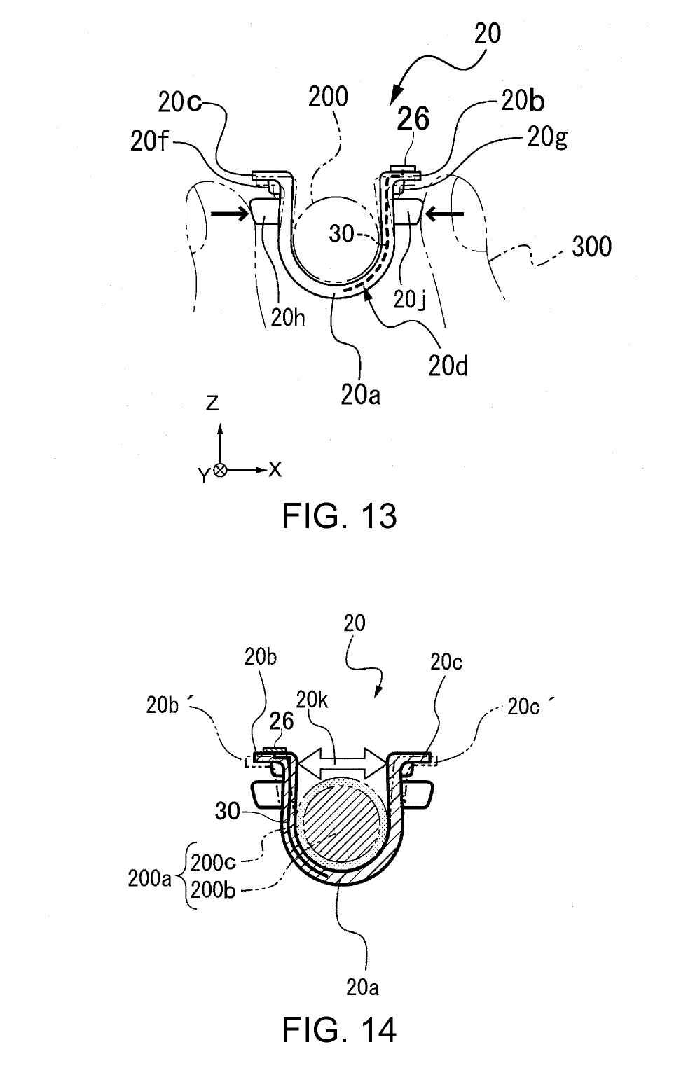

FIGS. 11 to 13 illustrate the holder 20, in which FIG. 11 is a plan view illustrating the related holder 20, FIG. 12 is a side view in which the holder 20 is viewed from an arrow direction indicated by G in FIG. 11, and FIG. 13 is a side view in which the holder 20 is viewed from a direction indicated by H in FIG. 11.

As illustrated in FIG. 13, the holder 20 includes an attachment surface 20a which is wound on and attached to the golf club 200 as a motion body, the fitting portion 20b as a projecting portion which is inserted into the groove 11d of the sensor 10 illustrated in FIGS. 9 and 10, projects in the −X direction, and extends in the Y direction, and the fitting portion 20c as a projecting portion which is inserted into the groove 11e, projects in the +X direction, and extends in the Y direction.

As illustrated in FIG. 12, one end 20d of the holder 20 in the ±Y direction is formed along an X-Z plane, but the other end 20e is formed in a shape along a circumferential plane Co intersecting the X-Z plane in this example. As a result, a planar shape of the other end 20e is a concave shape as illustrated in FIG. 11. The other end 20e is formed in the above-described way, and thus it is possible to realize a clear shape difference from the one end 20d. Therefore, for example, in a case where the sensor 10 fitted to the holder 20 has a function of designating a installation direction, the holder 20 is attached after the other end 20e having a different shape matches the golf club 200 as an indicator of the installation direction, and thus it is possible to prevent mistakes related to the installation direction of the sensor 10. The present embodiment is not limited to the configuration in which a shape of the other end 20e is different from that of the one end 20d, and a mark may be provided through simple marking or by using the antenna 30 which will be described later.

The holder 20 may be provided with detachment prevention protrusions 20f and 20g of the sensor 10. The detachment prevention protrusions 20f and 20g are engaged with the engaging portions (not illustrated) of the sensor 10 when the sensor 10 to be described later is installed, and thus prevent the sensor 10 from being separated from the holder 20. Since the detachment prevention protrusions 20f and 20g are provided, pressing protrusions 20h and 20j may be provided which cancel engagement of the detachment prevention protrusions 20f and 20g with the engaging portions of the sensor 10 when the sensor 10 is detached from the holder 20. When the sensor 10 is detached from the holder 20, the pressing protrusions 20h and 20j are pressed to an arrow direction with the fingers 300 as illustrated in FIG. 13 so that a distance between the detachment prevention protrusions 20f and 20g is reduced, and thus fitting to the fitting portions of the sensor 10 is removed. Therefore, the sensor 10 can be detached from the holder 20.

Next, a description will be made of a state in which the sensor 10 is installed in the holder 20. FIG. 14 is a sectional view illustrating a state in which the holder 20 is attached to the golf club 200. As illustrated in FIG. 14, the holder 20 is attached to the grip portion 200a of the golf club 200. The grip portion 200a has a configuration in which a shaft portion 200b is coated or wound with a nonslip grip rubber 200c. The grip rubber 200c is made of, for example, an elastic material such as rubber, urethane, or elastomer. A repulsive force which is generated due to compression with the shaft portion 200b caused by the attachment surface 20a of the holder 20 (an inner surface of the holder 20) increases a frictional force between the holder 20 and the grip rubber 200c, and thus it is possible to prevent the holder 20 from being positionally deviated from the golf club 200.

A form in which the motion detection device 100 according to the present embodiment is attached to the golf club 200 has been exemplified, but, for example, in a case where a nonslip portion is not provided at a grip portion 200a, an elastic member such as the grip rubber 200c in FIG. 14 may be interposed between a motion body and the attachment surface 20a of the holder 20, that is, the nonslip member may be disposed as a so-called interposed member. As a material of the interposed member, elastic resin such as rubber, urethane, or elastomer, or a soft metal is preferably used.

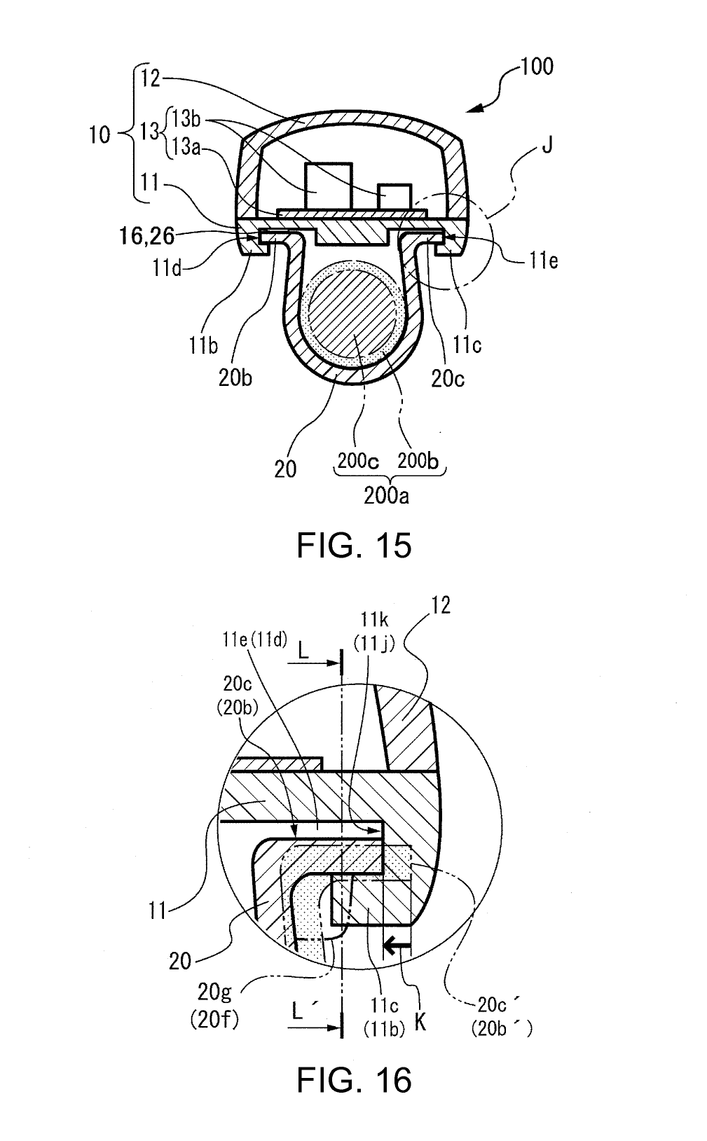

FIG. 15 is an assembly sectional view at a position corresponding to a B-B′ part illustrated in FIGS. 6 and 7 in a state in which the holder 20 is assembled with the sensor 10. Regarding assembling of the motion detection device 100, the sensor 10 is moved to the holder 20 attached to the golf club 200 in an arrow direction as illustrated in FIG. 2, the fitting portion 20b and the fitting portion 20c included in the holder 20 are inserted specifically, slid and inserted into the groove 11d and the groove 11e formed in the sensor 10 as illustrated in FIG. 15, and thus the sensor 10 is attached to the holder 20 which is attached to the golf club 200 so that the motion detection device 100 is assembled.

As illustrated in FIG. 14, if the holder 20 is attached to the grip portion 200a of the golf club 200, the grip rubber 200c of the grip portion 200a is interposed between the attachment surface 20a of the holder 20 and the shaft portion 200b. In this state, the attachment opening 20k opposing the attachment surface 20a is displaced so as to increase its width due to elasticity of the grip rubber 200c, and thus the fitting portion 20b and the fitting portion 20c enter states of a fitting portion 20b′ and a fitting portion 20c′ through outward movements thereof.

As illustrated in FIG. 15, the fitting portion 20b and the fitting portion 20c are inserted into the groove 11d and the groove 11e in the states of the fitting portion 20b′ and the fitting portion 20c′, and are thus corrected in a direction of an illustrated arrow K by a wall surface 11j of the groove 11e and a wall surface 11k of the groove 11e as illustrated in FIG. 16. In other words, in the state of the motion detection device 100 illustrated in FIG. 15, the holder 20 is corrected in a direction of compressing the grip rubber 200c, and can thus increase a holding force of the grip portion 200a of the holder 20. Therefore, positioning of the motion detection device 100 for the golf club 200 can be reliably performed, and thus a positional deviation is unlikely to occur due to an inertial force or an impact force which is applied to the motion detection device 100 by swinging the golf club 200, and appropriate swing data of the golf club 200 can be acquired.

As illustrated in FIG. 15, if the fitting portion 20b and the fitting portion 20c are respectively inserted into the groove 11d and the groove 11e, the first terminal 26 and the second terminal 16 come into contact with each other so as to cause electrical connection therebetween.

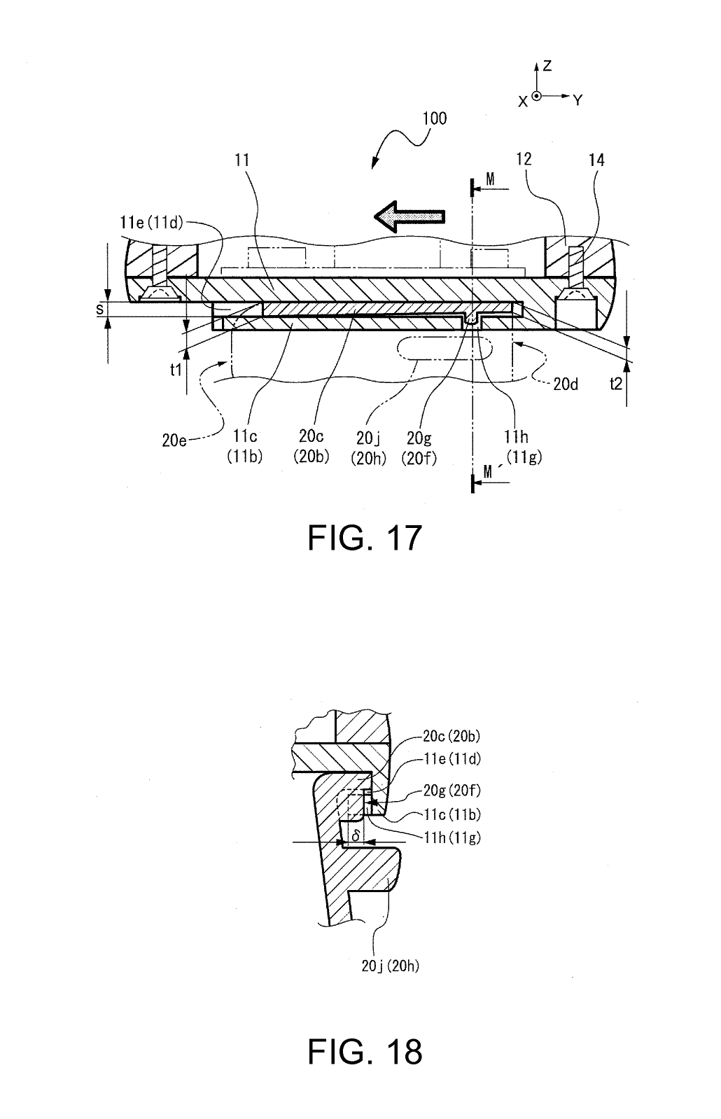

FIG. 17 is a schematic sectional view of an L-L′ part illustrated in FIG. 16. As illustrated in FIG. 17, the sensor 10 is moved in a direction of an illustrated arrow with respect to the holder 20 so that the fitting portion 20c of the holder 20 is relatively inserted into the groove 11e, and, similarly, the fitting portion 20b of the holder 20 is relatively inserted into the groove 11d, and thus the motion detection device 100 can be assembled. The L-L′ part in FIG. 16 corresponds to the groove 11e and the fitting portion 20c, and, thus, hereinafter, the groove 11e and the fitting portion 20c will be described an example. This is also the same for the groove 11d and the fitting portion 20b except that the first terminal 26 and the second terminal 16 are formed thereat. The first terminal 26 and the second terminal 16 may be formed at the groove 11e and the fitting portion 20c. In this case, dimensions of the groove 11e and the fitting portion 20c are defined so that the first terminal 26 and the second terminal 16 come into contact with each other when the fitting portion 20c is inserted and fitted into the groove 11e.

When the sensor 10 is inserted into the holder 20 in the direction of the illustrated arrow, first, the end of the fitting portion 20c on one end 20d side of the holder 20 starts being inserted into the groove 11e. A thickness (in the Z direction) t2 of the fitting portion 20c one end 20d side is formed to satisfy t2<s for a height s of the groove 11e in the Z direction. In other words, the thickness of the fitting portion 20c on one end 20d of the holder 20 is made smaller than the height of the groove 11e, and thus installation can be easily performed when the insertion is started.

The fitting portion 20c is relatively further inserted into the groove 11e, and, as illustrated in FIG. 17, the detachment prevention protrusion 20g of the holder 20 is fitted to the notch 11h formed in the protrusion 11c, and thus the insertion is completed. In this state, if a thickness t1 of the fitting portion 20c on the other end 20e of the holder 20 has a relationship of t1>t2, a gap between the groove 11e and the fitting portion 20c in the Z direction is narrower on the other end 20e than on one end 20d of the holder 20. Thus, for example, in a condition of t1≅s or t1>s, the fitting portion 20c is nipped by the surface of the groove 11e in the Z direction, and thus it is possible to prevent the sensor 10 from being dropping out of the holder 20. Rattling of the sensor 10 in the Z direction for the holder 20 is minimized, and thus it is possible to obtain appropriate swing data of the golf club 200.

In a case where the first terminal 26 and the second terminal 16 are respectively formed at the groove 11d and the fitting portion 20b, the thicknesses t1 and t2, and the height s of the groove 11e in the Z direction may be set as described above in consideration of dimensions of the first terminal 26 and the second terminal 16.

As illustrated in FIG. 15, the gap between the fitting portion 20b and the groove 11d is formed to an extent in which the first terminal 26 and the second terminal 16 come into contact with each other. For example, the size of the gap between the fitting portion 20b and the groove 11d is about a sum of the thicknesses of the first terminal 26 and the second terminal 16. The size of the gap between the fitting portion 20b and the groove 11d is appropriately designed so that the first terminal 26 and the second terminal 16 are unlikely to be damaged, and both of the terminals can be electrically connected to each other. In the example illustrated in FIG. 15, the first terminal 26 is formed on the curved plate-shaped surface (refer to the surface indicated by an arrow of 20b in FIG. 16) of the holder 20, and the second terminal 16 is formed on the surface of the sensor 10 directed toward the holder 20, but the first terminal 26 may be formed on the curved plate-shaped end surface (refer to the surface indicated by a line of 20b′ in FIG. 16) of the holder 20, and the second terminal 16 may be formed on the side surface (refer to the surface indicated by an arrow of 11j in FIG. 16) of the groove 11d of the sensor 10.

FIG. 18 is a schematically enlarged sectional view of an M-M′ part illustrated in FIG. 17. As illustrated in FIG. 18, the detachment prevention protrusion 20g is fitted to the notch 11h of the protrusion 11c with a fitting amount δ in a state in which the fitting portion 20c is inserted into the groove 11e. Consequently, the attachment state between the sensor 10 and the holder 20 illustrated in FIG. 17 is maintained.

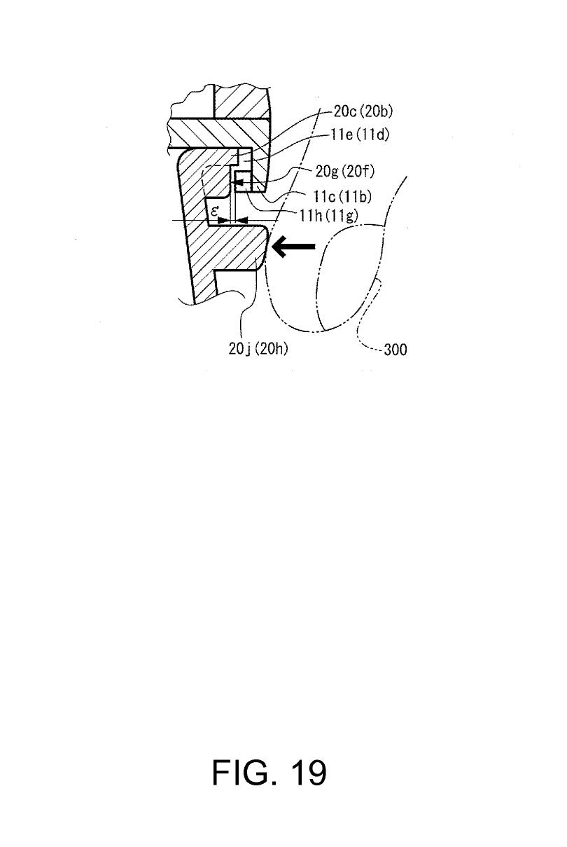

In a case where the sensor 10 is detached from the holder 20 in this state, as illustrated in FIG. 19, if the pressing protrusion 20j is pressed in a direction of an illustrated arrow, for example, with the fingers 300, the detachment prevention protrusion 20g is separated from the notch 11h so as to generate a gap ε (where ε>0), and, in this state, the sensor 10 is slid in a direction opposite to the arrow illustrated in FIG. 17. Therefore, the sensor 10 can be detached from the holder 20. As mentioned above, since the detachment prevention protrusions 20g and 20f, and the notches 11h and 11g to which the detachment prevention protrusions 20g and 20f can be fitted are provided, the sensor 10 can be reliably attached to the holder 20, and the sensor 10 can also be easily detached from the holder 20 as necessary.

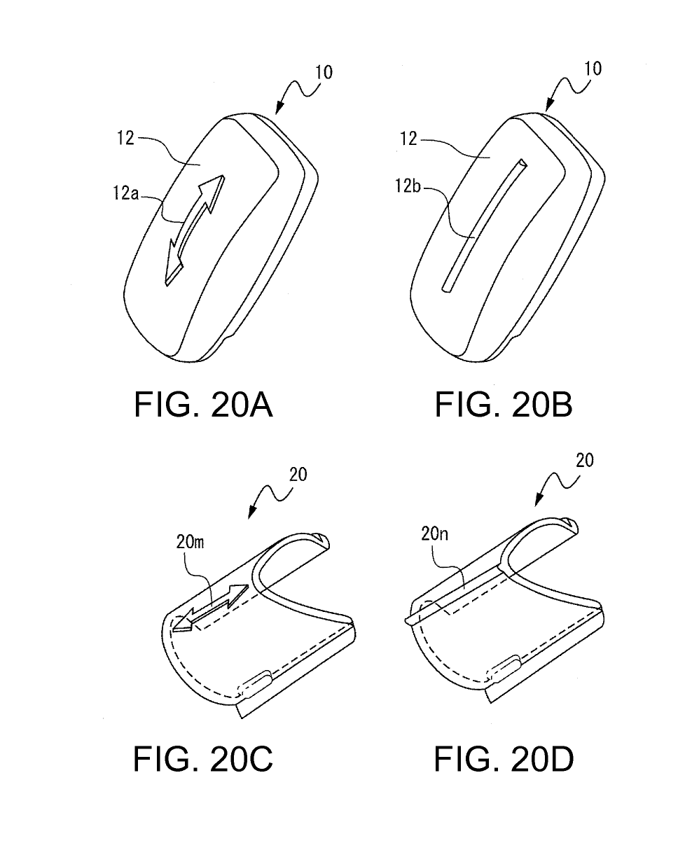

In a case where the electronic devices 13b provided in the motion detection device 100 include an inertial sensor having a detection axis, the motion detection device 100 is attached to the golf club 200, and, for example, the detection axis of the inertial sensor is positioned relative to the golf club 200. In this case, as a mechanism for clearly indicating a detection axis direction, detection axis direction indicators as illustrated in FIGS. 20A to 20D may be provided in the detection apparatus.

An aspect has been exemplified in which the direction indictors 12a, 12b, 20m and 20n illustrated in FIGS. 20A to 20B are all integrally formed with the protruding cover 12 or holder 20, but indicators are not limited thereto, and may have a concave shape formed through molding or engraving, or may be a printing mark. The indicators are not limited to an arrow shape or a linear shape, and may be marks having shapes which enable a direction to be identified.

If a direction indicator is provided in the holder 20, the antenna 30 to be described later may be used as the direction indicator (identification mark). For example, if the antenna 30 is extracted in a shape similar to an arrow shape or the golf club 200 and is visually recognized by a user, it is possible to display a desirable attachment direction to the user in an intuitively understandable manner. Instead of the protrusions indicated by the reference numerals 20m and 20n in FIGS. 20C and 20D, the antenna 30 may be provided in the same shape as those of the protrusions, and the antenna 30 may be disposed inside a corresponding protrusion so that a user can easily visually recognize the protrusion.

As other modification examples, for example, if the detection axis of the inertial sensor is set in a direction in which the groove or the fitting portion extends without providing the direction indicator, the detection direction can be made to match a predetermined direction only by performing an operation of fitting the base and the holder to each other, and thus it is possible to detect a motion with high accuracy. For example, if an angular velocity sensor is used as the inertial sensor, and an axial direction is set to the direction in which the groove or the fitting portion extends, angular velocity about a shaft axis can be detected with high accuracy, and thus it is possible to trace a change or the like in a face angle of a golf club head with high accuracy.

In the above-described motion detection device 100, the sensor 10 can be easily attached to the holder 20 which is attached to the golf club 200 only by sliding and fitting the sensor 10 so that the rail-shaped fitting portions 20b and 20c provided in the holder 20 are inserted into the grooves 11d and 11e provided in the sensor 10. Therefore, the first terminal 26 and the second terminal 16 can be electrically connected to each other.

Since the sensor 10 is attached to the holder 20, the grip rubber 200c provided in the grip portion 200a is compressed and interposed between the attachment surface 20a of the holder 20 and the shaft portion 200b so that a holding force of the motion detection device 100 for the golf club 200 can be increased, and thus it is possible to minimize a deviation of the attachment position due to an inertial force or an impact force which is applied to the motion detection device 100 as a result of swinging the golf club 200. Therefore, it is possible to obtain appropriate swing data of the golf club 200.

In addition to the slide-fitting structure, there maybe a structure in which the base and the holder are fitted to each other through mutual compressions by providing a depression such as a groove or a hole in one of the base and the holder and providing a projecting portion such as a protrusion in the other of the base and the holder. Even if any fitting method is selected, the first terminal 26 and the second terminal 16 are disposed at appropriate positions and in appropriate shapes, and thus it is possible to realize fitting between the holder 20 and the sensor 10, and contact between the first terminal 26 and the second terminal 16 with a simple operation.

### 1.6 First Terminal

The holder 20 includes the first terminal 26. The first terminal 26 is formed at the fitting portion 20b of the holder 20. In the illustrated example, the first terminal 26 is provided in a planar shape on the surface of the rail-shaped fitting portion 20b of the holder 20. The first terminal 26 may have a planar shape, and may have a probe shape so that a contact portion with the second terminal 16 is formed in a dot shape.

The first terminal 26 is electrically connected to the antenna 30. The connection between the first terminal 26 and the antenna 30 is not particularly limited, and may be performed through integral formation, and may be performed through only mechanical contact. The first terminal 26 and the antenna 30 maybe manufactured by disposing the holder 20 in a mold and molding the holder 20 in a state in which the terminal and the antenna are joined to each other in advance through crimping.

A shape of the first terminal 26 is not limited as long as electrical connection with the second terminal 16 is ensured. In the illustrated example, the first terminal 26 has a rectangular shape in a plan view. A thickness of the first terminal 26 is not also limited in the same manner, and maybe set as appropriate so as to match an aspect of mechanical coupling between the holder 20 and the sensor 10.

As illustrated in FIGS. 4, 5A to 5C, 11 and 12, and the like, if the first terminal 26 is provided at the rail-shaped fitting portion 20b and has a plate shape, the first terminal 26 may be formed (provided) so as to extend a length direction of the fitting portion 20b (rail). This is advantage in that the first terminal 26 and the second terminal 16 can be electrically connected to each other even if fitting between the fitting portion 20b and the groove 11d is insufficient in some degree, or insertion therebetween is insufficient. Consequently, it is possible to ensure wireless communication with high reliability regardless of the quality of attachment (assembly).

In this case, a length of the first terminal 26 in the length direction is more preferably equal to or greater than a half of a length of the fitting portion 20b (rail). The first terminal 26 is more preferably provided so as to avoid the end 20d of the holder 20 as illustrated in FIGS. 5A to 5C, 11 and 12, from the viewpoint of mechanical strength or abrasion resistance.

Materials of the first terminal 26 are not particularly limited as long as the materials are conductive, but may include metals such as gold, nickel, copper, SUS, and aluminum.

### 1.7 Second Terminal

The sensor 10 includes the second terminal 16. The second terminal 16 is formed at a portion of the sensor 10 which is fitted to the holder 20. In the illustrated example, the terminal is formed in planar shapes inside the groove 11d of the sensor 10. The second terminal 16 may have a planar shape, and may have a probe shape so that the contact portion with the first terminal 26 is formed in a dot shape.

The second terminal 16 is electrically connected to the first communication unit 130 provided in the sensor 10. Connection between the second terminal 16 and the first communication unit 130 is not particularly limited, and may be performed by using a wiring or the like as appropriate. A shape of the second terminal 16 is not limited as long as electrical connection with the first terminal 26 can be ensured. In the illustrated example, the second terminal 16 has a rectangular shape in a plan view. A thickness of the second terminal 16 is not also limited.

As illustrated in FIGS. 7 and 10, and the like, if the second terminal 16 is provided at the groove 11d and has a plate shape, the second terminal 16 may be formed (provided) so as to extend a length direction of the groove 11d. This is advantage in that an electrical contact point between the sensor 10 and the antenna 30 can be formed even if fitting between the fitting portion 20b and the groove 11d is insufficient in some degree, or insertion therebetween is insufficient. Consequently, it is possible to ensure wireless communication with high reliability regardless of the quality of attachment (assembly). If at least one of the first terminal 26 and the second terminal 16 is provided so as to extend in the length direction of the fitting portion 20b or the groove 11d, such an effect can be achieved.

In this case, a length of the second terminal 16 in the length direction is more preferably equal to or greater than a half of a length of the groove 11d (groove). The second terminal 16 is more preferably provided so as to avoid the end point (end) of the groove 11d as illustrated in FIGS. 7 and 10, from the viewpoint of mechanical strength or abrasion resistance.

Materials of the second terminal 16 are not particularly limited as long as the materials are conductive, but may include metals such as gold, nickel, copper, SUS, and aluminum.

### 1.8 Antenna

The holder 20 includes the antenna 30 which is electrically connected to the first terminal 26. In other words, the antenna 30 is provided in the holder 20, transmits a radio wave to an external device and/or receives a radio wave from the external device (a second communication unit 510 or the like of the external device) (refer to FIG. 22) by using power supplied from the first communication unit 130 (refer to FIG. 22) of the sensor 10, and transmits a signal to the first communication unit 130 of the sensor 10.

The antenna 30 is electrically connected to the first terminal 26, the first terminal 26 is connected to the second terminal 16, and thus the antenna 30 is connected to the first communication unit 130 of the sensor 10 so as to transmit and receive an electric wave. The antenna 30 may be of a chip type, and may have a linear shape as illustrated.

A shape of the antenna 30 is not particularly limited, but may be, for example, a dot shape (chip type), a linear shape (refer to each drawing), a branched shape, a plate shape, or a mesh shape. In the illustrated example, as terminals for supplying power to the antenna 30, a set of the first terminal 26 and the second terminal 16 is provided, but other terminals may be provided so as to supply a plurality of types of power to the single antenna 30. In addition, a plurality of antennas 30 may be provided, and a plurality of terminals which supply power may be provided so as to correspond to the respective antennas 30. Here, the phrase, “power is supplied” is used, but the antenna 30 may receive an electric wave. Both the first communication unit 130 and a second communication unit 510 which will be described later can perform transmission and reception, and can perform communication with each other via the antenna 30. In such a configuration, the transmission and reception functions may be switched by using a switch (not illustrated) so as to be realized.

In a case where the antenna 30 is provided in the linear shape as illustrated, a length of the antenna 30 can be made greater than a diameter of the holder 20 by folding (bending) the antenna 30. As illustrated in FIGS. 4, 5A to 5C, 11 and 12, and the like, by disposing the antenna 30 in a folded shape (bent shape), the antenna 30 having transmission and reception portions which are greater than the size of the holder 20 can be provided. In the above-described way, it is possible to perform transmission and reception with higher sensitivity. As illustrated in FIG. 5C, when the curve plate shape of the holder 20 is virtually developed and is viewed as a plate shape, the entire length of the antenna 30 can be made greater than the maximum length ML (the maximum diameter) of the holder 20. Consequently, since the length of the antenna can be increased, it is possible to increase sensitivity of transmission and reception of an electric wave.

Regarding a position where the antenna is disposed in the holder 20, the antenna is preferably disposed so as to cover the circumference of the golf club 200 when attached to the golf club 200. For example, in the examples illustrated in FIGS. 4, 5A to 5C, 11 and 12, and the like, the antenna is disposed so as to cover about a half of the circumference of the golf club 200. In the above-described way, an electric wave is unlikely to be shielded by each constituent element of the golf club 200 or the sensor 10 even in a state in which reception equipment or transmission equipment having high directionality is disposed around the golf club 200, and it is possible to perform transmission and reception with higher sensitivity.

The antenna 30 may be formed along the surface of the holder 20, and may be formed so as to be embedded inside the holder 20 (so as to be covered with a material forming the holder 20). The antenna 30 is embedded in the holder 20, and thus it is possible to minimize deterioration such as rust on the antenna 30. The antenna 30 is embedded in the holder 20, and thus it is possible to prevent disconnection of the antenna 30 due to an external force or the like.

Materials of the antenna 30 are not particularly limited as long as the materials are conductive, but may include metals such as gold, nickel, copper, SUS, and aluminum. As a material of the antenna 30, a transparent conductor such as ITO may be used. As described above, the antenna 30 may be used as a direction indicator which indicates an attachment direction of the holder 20 to a motion body (golf club 200) to a user. In this case, it is possible to achieve an effect of further increasing visibility of the direction indicator by forming the antenna 30 through a combination between the transparent conductor and a metal.

The antenna 30 is designed so as to have impedance (for example, 50 Ω) suitable to be used for predetermined wireless communication. However, impedance of the antenna 30 is not limited to such design, and may be designed in consideration of comprehensive impedance, including, for example, at least one of the first terminal 26, the second terminal 16, and other wirings.

### 1.9 Operations and Effects

In the holder 20 according to the present embodiment enables the sensor 10 to be miniaturized, and enables wireless communication with an external device to be efficiently performed when attached to a motion body such as the golf club 200 which is moved.

In other words, in the related art, the sensor unit 13 is stored in the sensor 10, and, for example, a chip type antenna is stored and provided in the sensor 10 in order to transmit a measurement result in the sensor unit 13 in a wireless manner. In such an arrangement of the related art, there is a case where a radio wave is shield by a member or a constituent element around the sensor 10, or a measurement target object (for example, the golf club 200), and thus signal intensity is reduced. For this reason, when the antenna is provided in the sensor 10, there are various limitations such as an arrangement of a member or a constituent element around the antenna or provision of a space around the antenna, and thus this is a hindrance to miniaturization of, especially, the sensor 10.

In contrast, as in the motion detection device 100 of the present embodiment, since the antenna 30 is disposed in the holder 20 instead of the inside of the sensor 10, it is possible to minimize shield of an electric wave in the constituent element of the sensor 10 and thus to miniaturize the sensor 10. Since the antenna is disposed in the holder 20, it is possible to minimize shield of an electric wave in a motion body (the golf club 200 or the like) to which the motion detection device 100 is attached, and thus to increase, for example, a degree of freedom of arrangements of specifications of external transmitters and receivers.

### 2. Motion Detection Device

The motion detection device 100 according to the present embodiment includes the above-described antenna 30 which is provided in the above-described holder 20 and is connected to the first terminal 26, and the above-described sensor 10 provided with the second terminal 16 which comes into contact with the first terminal 26. The motion detection device 100 has a small size, and can efficiently perform wireless communication with an external device when attached to a motion body which is moved. Consequently, it is possible to obtain motion information of the motion body with high sensitivity by using the wireless communication.

Since the antenna 30 is provided in the holder 20 instead of the inside of the sensor 10, the sensor 10 can be miniaturized, and shield of an electric wave in a motion body (a motion analysis target) held by the holder 20 is unlikely to occur. Therefore, it is possible to perform stable communication with an external device by using the electric wave.

3. Motion Body with Sensor

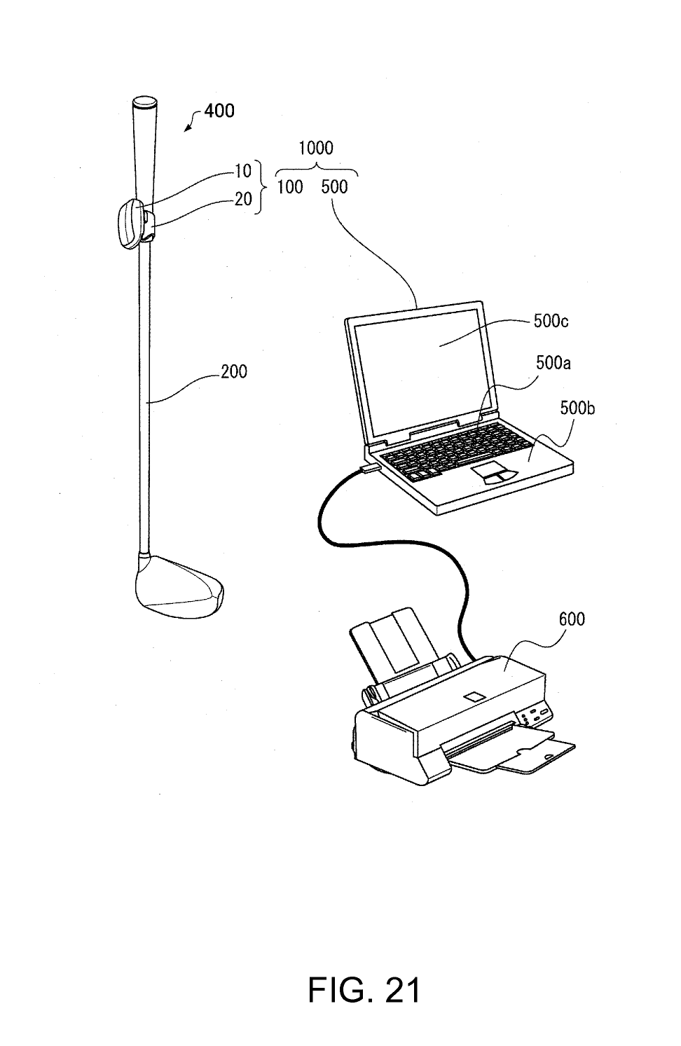

A motion body 400 with sensor according to the present embodiment is an motion body such as the golf club 200, and is attached with the above-described motion detection device 100 (refer to FIG. 3 or 21). The motion body 400 with sensor can perform information communication using a radio wave with an external communication apparatus (a portable information terminal such as a smart phone, a personal computer, or the like) with high sensitivity, and can thus perform motion analysis with high accuracy.

### 4. Motion Analysis Apparatus

FIG. 21 is an exterior view illustrating a motion analysis apparatus according to the present embodiment. As illustrated in FIG. 21, a motion analysis apparatus 1000 (hereinafter, referred to as an analysis apparatus 1000) according to the present embodiment includes the above-described motion detection device 100, and a computer 500 which acquires motion data of the golf club 200 as a motion body, obtained by the motion detection device 100, and analyzes the motion data. The computer 500 includes a processing unit 500b provided with an input section 500a, and a display unit 500c which displays a processing result. In the illustrated example, the personal computer 500 (hereinafter, referred to as a PC 500) is provided, but a portable terminal such as a tablet terminal or a smart phone may be connected to the motion detection device 100 in a wireless manner. A printer 600 may be provided as an external output apparatus for recording an analysis result in the PC 500. In the present embodiment, data is transmitted and received between the motion detection device 100 and the PC 500 via wireless communication.

FIG. 22 is a block diagram of the analysis apparatus 1000 illustrated in FIG. 21. As illustrated in FIG. 22, the sensor 10 provided in the motion detection device 100 includes at least an inertial sensor 110 (sensor unit), a data storage unit 120 which stores data while processing the data, and the first communication unit 130 including a transmission section 132 which transmits data to the PC 500 and a reception section 131 which receives data from the PC 500. The PC 500 provided in the analysis apparatus includes the processing unit 500b and the display unit 500c as described above. The processing unit 500b is provided with a second communication unit 510 including a reception section 511 which receives data transmitted from the first communication unit 130 of the sensor 10 via the second terminal 16 and the first terminal 26, and the antenna 30 provided in the holder 20, and a transmission section 512 which transmits an electric wave to the first communication unit 130, and a motion analysis unit 520 which processes and analyzes acquired detection data. The display unit 500c displays an analysis result in the motion analysis unit 520. The printer 600 as an external output apparatus of the analysis result is provided. The PC 500 includes an antenna (not illustrated) which performs wireless communication with the antenna 30.

An example of an operation of the analysis apparatus 1000 will be described. If a user swings the golf club 200 attached with the motion detection device 100, the inertial sensor 110 detects an inertial force, and transmits the detection data to the data storage unit 120. The data storage unit 120 processes the data in a data format which can be transmitted to the PC 500 and accumulates (stores) the data until receiving a transmission instruction from the PC 500. After a predetermined swing for motion analysis is completed, a motion analysis operation is started. If an analysis starting command is given to the processing unit 500b via the input section 500a (not illustrated), an instruction for transmission of detection data is transmitted from the transmission section 512 of the second communication unit 510 to the first communication unit 130 in a wireless manner. A related radio wave is received in the antenna 30, and the detection data stored in the data storage unit 120 is transmitted to the processing unit 500b from the transmission section 132 via the antenna 30 by using a radio wave on the basis of the command transmitted to the reception section 131 of the first communication unit 130.

The detection data received by the reception section 511 of the second communication unit 510 is transmitted to the motion analysis unit 520, and motion analysis of the golf club 200 is performed on the basis of a predetermined analysis program. An analysis result is displayed as an image on the display unit 500c of the PC 500, or is recorded on a recording medium and is output by the printer 600 as an external output apparatus.

Since the motion analysis apparatus 1000 according to the present embodiment includes the above-described motion detection device 100, the motion detection device 100 is attached to a motion body (for example, the golf club 200), and thus it is possible to perform wireless communication with favorable sensitivity and high reliability. Consequently, wireless connection between the first communication unit 130 and the second communication unit 510 can be stably performed, and thus it is possible to perform motion analysis with higher accuracy. The motion analysis apparatus 1000 according to the present embodiment allows the motion detection device 100 to be easily attached to and detached from the exemplified motion body (the golf club 200). Thus, for example, even in a case where features of a plurality of motion bodies are analyzed, cost for analysis can be reduced since only a set of motion detection devices 100 may be prepared. Since the sensor is not attached to a motion body by using an adhesive member, it is possible to reduce analysis preparation time and to easily detach the sensor from the motion body after an analysis is completed, and also to reduce analysis time and to prevent dirt such as an adhesive from being attached to the motion body. Therefore, it is possible to analyze motion characteristics of the motion body without reducing a commercial value of the motion body.

The invention is not limited to the above-described embodiment, and may be further variously modified. For example, the invention includes substantially the same configuration (for example, a configuration in which functions, methods, and results are the same) as the configuration described in the embodiment. The invention includes a configuration in which an inessential part of the configuration described in the embodiment is replaced with another part. The invention includes a configuration which achieves the same operation and effect or a configuration capable of achieving the same object as in the configuration described in the embodiment. The invention includes a configuration in which a well-known technique is added to the configuration described in the embodiment.

The entire disclosure of Japanese Patent Application No. 2014-229800, filed Nov. 12, 2014 is expressly incorporated by reference herein.

What is claimed is:

1. A motion detection device which is attached to a motion body and detects a motion thereof, comprising:
a sensor that detects the motion; and
a holder that includes a fixation unit which is attached to the motion body so as to fix the sensor to the motion body,
wherein the holder further includes a first terminal that is provided at the fixation unit, and an antenna that is connected to the first terminal, and
wherein the sensor includes a second terminal that is electrically connected to the first terminal when attached to the holder.

2. The motion detection device according to claim 1,
wherein the fixation unit of the holder and the sensor are respectively provided with fitting portions, and
wherein the fitting portions are fitted to each other, and thus the sensor and the holder are fixed to each other.

3. The motion detection device according to claim 2,
wherein the first terminal and the second terminal are respectively provided at the fitting portions of the fixation unit of the holder and the sensor.

4. The motion detection device according to claim 1,
wherein the holder is formed of a curved plate, and
wherein the antenna is provided inside the curved plate of the holder.

5. The motion detection device according to claim 1,
wherein the antenna is provided in the holder in a folded shape.

6. The motion detection device according to claim 1,
wherein information is transmitted and received by using the antenna, and the transmitted and received information is transmitted to the sensor.

7. A motion body attached with the motion detection device according to claim 1.
